(19) United States
(12) Patent Application Publication
(10) Pub. No.: US 2024/0103920 A1
(43) Pub. Date: Mar. 28, 2024

(54) METHOD AND SYSTEM FOR ACCELERATING THE CONVERGENCE OF AN ITERATIVE COMPUTATION CODE OF PHYSICAL PARAMETERS OF A MULTI-PARAMETER SYSTEM

(71) Applicant: FRAMATOME, COURBEVOIE (FR)

(72) Inventors: Viken KHAYIGUIAN, LYON (FR); Maëva DELAPORTE, LYON (FR); Arno GARCIA, CLERMONT FERRAND (FR); Nicolas GOREAUD, LYON (FR)

(21) Appl. No.: 18/200,781

(22) PCT Filed: Nov. 23, 2020
(86) PCT No.: PCT/IB2020/001148

§ 371 Date: May 23, 2023

(51) Int. Cl. G06F 9/50; G06F 30/28

(52) U.S. Cl. CPC G06F 9/5027; G06F 30/28

(57) ABSTRACT

A method and system for accelerating the convergence of an iterative computation code of physical parameters of a multi-parameter system, in particular in the field of fluid dynamic computation. The method comprises obtaining first parameter values, of first dimensionality by applying the iterative computation code. The method further comprises applying a data dimensionality reduction on at least a part of the first parameter values of first dimensionality to compute representative second parameters of second dimensionality smaller than the first dimensionality; applying an extrapolation on at least a subset of the second parameters of second dimensionality to predict a set of predicted second parameter values, computing predicted first parameter values from the predicted second parameter values, and using the predicted first parameter values as an input data set for a new iterative computation with the iterative computation code.

The present disclosure concerns a method and system for accelerating the convergence of an iterative computation code of physical parameters of a multi-parameter system.

The present disclosure belongs to the field of computation optimization of physical parameters of a multi-parameters system, and applies particularly to fluid dynamic computation.

### BACKGROUND

In various application fields it is necessary to compute the physical parameters of multi-parameters systems, and the corresponding computations are performed by using software designed to solve complex physical problems.

For example, the field of computation fluid dynamics (CFD) uses numerical analysis and data structures to analyze and solve problems that involve fluid flows. Such physical problems involve highly non-linear equations with numerous parameters, and solving these physical problems implies intensive iterative computations.

In other technical areas, intensive iterative computations are necessary to reach convergence of parameters in a multi-parameter system.

These iterative computations use intensively computation resources, and furthermore the computation time before reaching convergence is long. It appears useful to find solutions to reduce the computation time and the use of computation resources for such computations.

A classical solution known for reducing computation time is to apply massive parallelization using multi-core processing clusters. However, massive parallel computations reach a limit when the communication time between computing units becomes non negligible compared to the computational time. This defines a maximal size of the cluster to run parallel computations. Increasing the size of the cluster does not reduce the computational time. Furthermore, the use of processing resources is not reduced, and might even be increased with the use of massive parallel computation platforms.

### SUMMARY

The present disclosure aims to remedy to the drawbacks of the prior art.

To that end, the present disclosure proposes a method for accelerating the convergence of an iterative computation code of physical parameters of a multi-parameter system, in particular in the field of fluid dynamic computation, comprising the following steps, implemented by a processor of an electronic programmable device:
a) apply the iterative computation code, starting from an input data set, for a given number of iterations, to obtain first parameter values, of first dimensionality,
b) keep available, in a memory of said programmable device, the first parameter values for each iteration for post-processing,
c) check for iterations convergence according to a convergence criterion,
d) if the convergence criterion is not satisfied then:
   apply a data dimensionality reduction on at least a part of the first parameter values of first dimensionality to compute representative second parameters of second dimensionality smaller than the first dimensionality;
   apply an extrapolation on at least a subset of the second parameters of second dimensionality to predict a set of predicted second parameter values, and compute predicted first parameter values from the predicted second parameter values,
   use the predicted first parameter values as an input data set for a new iterative computation with the iterative computation code,
e) repeat steps a) to d) until the convergence according to the predetermined convergence criterion is reached.

Advantageously, the method of the present disclosure applies, if a predetermined convergence criterion is not reached after a given number of iterations, a data dimensionality reduction and an extrapolation method to obtain parameter values as a new starting point of the iterative computation code. Thanks to the dimensionality reduction, the computational resources used to perform the extrapolation are low and the extrapolation is feasible. The extrapolation reduces the need for iterations before reaching a converged solution, and the computing time is reduced as a consequence.

In embodiments of the present disclosure, the method for accelerating the convergence of an iterative computation code of physical parameters of a multi-parameter system comprises one or more of the following features, considered alone or according to all technically possible combinations.

The data dimensionality reduction comprises applying principal component analysis, and each representative second parameter is a principal component.

Each principal component has an associated score, and the principal components are ordered according to decreasing associated score.

The data dimensionality reduction comprises applying an upstream first neural network, which is obtained by splitting an identity multi-layer neural network, comprising at least one hidden layer with a number of neurons smaller than the first dimensionality.

The computation of predicted first parameter values from the predicted second parameter values comprises applying a downstream second neural network, obtained by splitting said identity multi-layer neural network.

The extrapolation comprises applying auto-regressive integrated moving average.

The extrapolation comprises applying a parameterized algorithm trained on an available database.

The extrapolation comprises applying a computational extrapolation to predict second parameter values and store the predicted second parameter values as trajectories, and further apply training of the parameterized algorithm based on the stored trajectories.

The method further comprises, after applying the data dimensionality reduction, computing a variation rate of values of at least one chosen second parameter associated to successive iterations of steps a) to d), and determining the subset of the second parameters used for extrapolation in function of said variation rate.

The method wherein the data dimensionality reduction is principal component analysis, the principal components being ordered, and wherein said variation rate is computed for the first principal component.

The determining the subset of the second parameters used for extrapolation comprises comparing the variation rate to a predetermined threshold, and selecting second parameter values associated to iterations for which the variation rate is lower than said predetermined threshold.

According to another aspect, the present disclosure concerns a device for accelerating the convergence of an iterative computation code of physical parameters of a multi-parameter system for accelerating the convergence of an iterative computation code of physical parameters of a multi-parameter system, in particular in the field of fluid dynamic computation. The device comprises at least one processor configured to implement:
a module applying the iterative computation code, starting from an input data set, for a given number of iterations, and obtaining first parameter values, of first dimensionality,
a module configured to keep available, in a memory of the device, the first parameter values for each iteration for post-processing,
a module configured to check for iterations convergence according to a convergence criterion, further comprising modules configured to, if the convergence criterion is not satisfied:
   apply a data dimensionality reduction on at least a part of the first parameter values of first dimensionality to compute representative second parameters of second dimensionality smaller than the first dimensionality;
   apply an extrapolation on at least a subset of the second parameters of second dimensionality to predict a set of predicted second parameter values, and compute predicted first parameter values from the predicted second parameter values,
   use the predicted first parameter values as an input data set for a new iterative computation with the iterative computation code,
wherein the modules are applied repeatedly until the converge according to the predetermined convergence criterion is reached.

According to another aspect, the present disclosure concerns a computer program comprising instructions for implementing a method for accelerating the convergence of an iterative computation code of physical parameters of a multi-parameter system as briefly described above when it is executed by a processor of a programmable device.

According to another aspect, the present disclosure concerns a recording medium for recording computer program instructions implementing a method for accelerating the convergence of an iterative computation code of physical parameters of a multi-parameter system as briefly described above when the computer program is executed by a processor of a programmable device.

### BRIEF SUMMARY OF THE DRAWINGS

Further characteristics and advantages of the present disclosure will become apparent from the following description, provided merely by way of non-limiting example, with reference to the enclosed drawings, in which:

FIG. 1 is a flowchart of a method for accelerating the convergence of an iterative computation code of physical parameters of a multi-parameter system according to a first embodiment of the present disclosure;

FIG. 2 schematically represents a neural network for applying dimensionality reduction and expansion according to an embodiment;

FIG. 3 is a flowchart of an alternative embodiment of extrapolation;

FIG. 4 is a flowchart of a method for accelerating the convergence of an iterative computation code of physical parameters of a multi-parameter system according to a second embodiment of the present disclosure;

FIG. 5 is a block diagram of a device for accelerating the convergence of an iterative computation code of physical parameters of a multi-parameter system according to an embodiment.

### DETAILED DESCRIPTION

The present disclosure will be described hereafter in the context of accelerating the convergence of an iterative computation code in the field of fluid dynamics computation.

A particular application can be found in the field of nuclear plant reactors, for example for simulating and predicting the temperature inside a reactor building during normal operation. In this application a multi-parameter system is obtained from parameters characterizing fluid flows and temperature field inside a reactor building comprising several rooms, venting systems and power sources.

The geometry of such a building is very large (tens of meters wide and high) and very complex with lots of rooms, doors and equipments. As a result in order to compute a solution to the non-linear differential equations of fluid motion and energy, computer codes rely on a fine spatial discretization of such a geometry, including millions of elements. Reaching a converged solution of the equations at equilibrium state requires thousands of iterations of a solver. Even on a large cluster with hundreds of processing units, this process can take more than 12 hours if not several days to complete.

However, the present disclosure is not limited to this field of application, and can be applied more generally for computing physical parameters of multi-parameters systems by applying iterative computations.

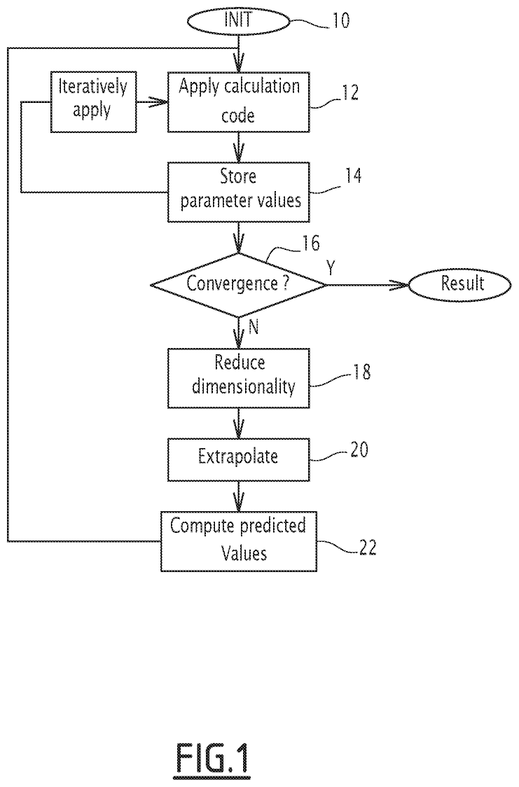

FIG. 1 is a flowchart of the main steps of a first embodiment of a method of accelerating the convergence of an iterative computation of physical parameters of a multi-parameter system.

A set of data 10 is provided as an initial input to a computation step 12 of an iterative computation code. The set of data 10 comprises initial values of the physical parameters of the multi-parameter system, called hereafter first parameters. The number N of first parameters of the multi-parameter system is called the first dimensionality of the first parameter space. For example, the physical parameters of a multi-parameter system in the field of CFD include temperature, velocities, flow rate etc, at different cells of mesh of the discretized geometry.

The multi-parameter system is simulated using a scientific computation toolkit software, for example Simcenter STAR-CCM+®.

A set of output first parameter values is obtained after applying the computation step 12, stored at step 14 for post-processing and provided as an input for a next iteration of the computation step 12. An initial number P of iterations is applied.

The method further comprises a step 16 of checking whether at least one predetermined convergence criterion is verified after the initial number of P iterations of the computation.

For example, typical convergence criteria used are
Stability of the solution at key locations of the discretized geometry model (example: less than 10⁻³ C variation over the last 5 iterations at the point where a sensitive material is located);
Stability of the moving average of the solution over the B hundreds last performed iterations when the solution is oscillating (e.g.: stability of the moving average of the natural convection flowrate inside the building during the last performed 500 iterations)
Decrease of the residuals by three orders of magnitude. Solving a differential equation can always be expressed as finding the parameters pᵢ such as f(pᵢ)=0, f being the equation to be solved. In practice reaching 0 is very hard and computer programs reach a situation where f(pᵢ)=ε, ε is called the residual. Its initial value is normalized to 1. Convergence is typically declared when the parameters pᵢ lead to ε=0.001 for all the equations f to be solved.

In case of positive validation of the convergence criterion or criteria at step 16, the set of output first parameter values obtained by the last application of the computation code is considered to be a valid result of the iterative computation code. Therefore, the computation process ends.

In case of negative validation of the converge criterion or criteria, step 16 is followed by step 18 of applying a data dimensionality reduction method, also called parameter space compression, consisting in reducing the dimensionality of the first parameter space, from the first dimensionality N to a second dimensionality M smaller than N. A second parameter space of second dimensionality is obtained.

In an embodiment, a principal component analysis (PCA) is applied.

The first parameter values previously computed and memorized, for at least a subset of the P iterations of the computation code applied, are extracted from memory and processed.

The PCA is a well-known statistical procedure that uses an orthogonal transformation to convert a set of observations (input data) of possibly correlated variables into a set of linearly uncorrelated variables called principal components. Each principal component has an associated score, for example an associated variance. The principal components are ordered in an order of decreasing score, e.g. variance, such as the first principal component has the largest score, which means that the first principal component accounts for the largest variability in the input data. Therefore, maintaining the first M principal components obtained results in dimensionality reduction. For example, the sets of first parameter values of the last Q iterations are used for the principal component analysis.

In an embodiment, the initial number of iterations P is comprised between 200 and 600 and the number Q is comprised between 20 and 60.

The second parameter space has a reduced second dimensionality, since the number M of second parameters is smaller than the number N of first parameters.

Sets of second parameter values are computed from the memorized sets of first parameter values.

An extrapolation method is then applied in an extrapolation step 20 for at least a chosen subset of second parameters.

In an embodiment, an auto-regressive integrated moving average (ARIMA) model is used for the extrapolation of each second parameter, based on the memorized sets of second parameter values.

The ARIMA statistical model is based on the study of temporal series of the values of a given variable to compute a predicted value at a future time of the given variable. The ARIMA statistical model is defined by several model parameters which are computed from the temporal series of observations. For example, in an embodiment, an extrapolation model ARIMA (1, 1, 0) is used. Such a model is defined by the following equation:

y(i)=φ·y(i−1)+μ+ε·i (EQ51)

Where φ, μ and ε are the ARIMA model parameters, and i is an index of iteration.

The variable y(i) is a given second parameter which is a principal component obtained at the dimensionality reduction step 18, the temporal series being the second parameter values computed by the successive iterations.

The extrapolation is applied for each second parameter of the chosen subset of second parameters.

In an embodiment, the extrapolation is applied for each second parameter.

Given a temporal series of length Len₁, the value y(Len₁) is known for a given second parameter. The formula (EQ1) allows the computation of a predicted value y(Len₁+Δ) of said second parameter at Len₁+Δ where Δ is for example comprised between 100 and 1000, for example equal to 300.

A set of predicted second parameter values is therefore obtained by computation.

The ARIMA statistical model described above is an example of implementation. It is to be understood that other extrapolation methods may be used to compute a set of predicted second parameter values.

Finally, a set of predicted first parameter values is computed at step 22 from the set of predicted second parameter values, by applying an inverse orthogonal transformation corresponding to the orthogonal transformation applied in step 18.

The set of predicted first parameters is then used as a set of input parameter values, and the steps 12 to 16 are repeated. If the convergence criterion is not reached at step 16, steps 18 to 22 are also repeated.

Advantageously, when the extrapolation is accurate, the set of predicted first parameters constitute a more accurate set of input parameters and the convergence criterion is reached quicker than without applying step 18 to 22.

According to a variant, neural networks are used for parameter space compression (step 18), and for computing predicted values (step 22). In this alternative embodiment, an “identity” neural network is trained to associate a set of N input parameters with the identical set of N output parameters.

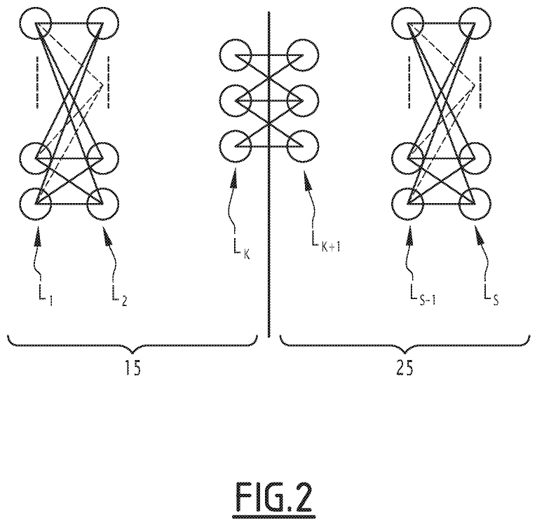

Such a neural network is schematically represented in FIG. 2. The neural network has an architecture comprising a number S of layers, the first layer L₁ and the last layer L_{S} comprising N neurons. The number S of layers is a chosen parameter. All neurons of a layer are connected to all neurons of a following layer in the neural network architecture. However, in order to keep the drawing simple, not all interconnections are represented.

An additional constraint is performed in the architecture of the neural network, with reduced number of neurons in the middle layers forming a bottleneck, for example layers Lₖ. and Lₖ₊₁. Each of these layers Lₖ, Lₖ₊₁ comprises a number M of neurons, M being the second dimensionality of the second parameters space, which is smaller than the first dimensionality N of the first parameter space.

After this neural network is successfully trained, it can be split into two neural networks:
An upstream first neural network 15, between the input parameters and the bottleneck layer Lₖ in the neural network, acting as a non-linear compressor;
A downstream second neural network 25, between the bottleneck layer Lₖ₊₁ and the output parameters, acting reversely as a non-linear de-compressor.

The parameters defining the upstream first neural network 15 and the downstream second neural network 25, obtained by suitable training, are stored in memory.

The upstream first neural network 15 is applied for dimensionality data reduction 18.

The downstream second neural network 25 is applied for computing 22 a set of first parameter values.

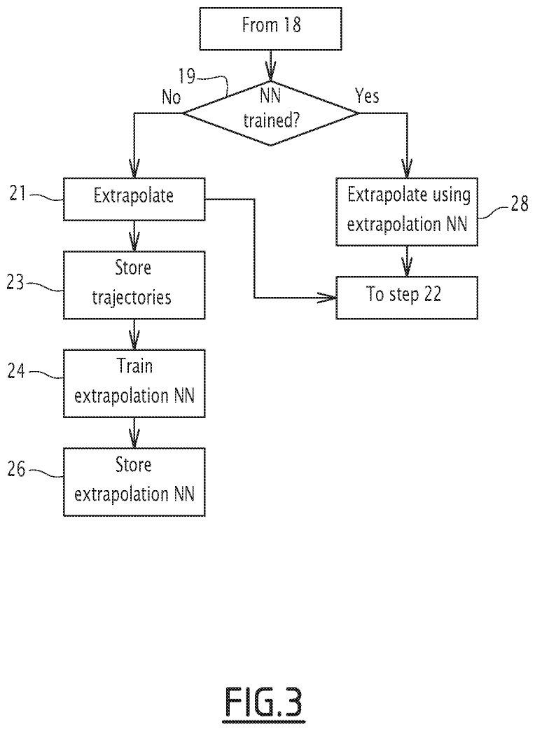

FIG. 3 is a flowchart of the main steps of an alternative embodiment of the extrapolation step 20.

In this alternative embodiment, it is checked at checking step 19 whether an extrapolation neural network is trained.

In case of negative answer, checking step 19 is followed by an extrapolation step 21. An extrapolation method, analogous to the method described with reference to step 20, is applied for at least a chosen subset of second parameters. For example, an extrapolation based on an ARIMA model is applied.

The extrapolation may be considered as a temporal trajectory of at least one second parameter. The result of the extrapolation 21, i.e. the computed trajectory, is stored in memory, for example in a training database, gathering data for a neural network training.

When the training database is populated with enough trajectories, an extrapolation neural network training step 24 is applied. Such extrapolation neural network can be trained to predict the end of a trajectory knowing the start of said trajectory, via for instance a standard “dense” network associating the end of a trajectory with the start of the trajectory. As an alternative such extrapolation neural network can be trained to recursively predict the path of a trajectory knowing the start of the trajectory, using a recursive neural network method such as the NARX method.

The parameters defining the extrapolation neural network are stored at storing step 26, as well as a variable recording the availability of the trained extrapolation neural network.

The process continues by repeating steps 12 to 18 as explained above, and at a next iteration, step 18 is followed by step 28 applying the trained extrapolation neural network. In step 28, an extrapolation is applied based on an interpolation performed applying the trained neural network.

Advantageously, the training of the extrapolation neural network is part of the method of accelerating the convergence of an iterative computation of physical parameters of a multi-parameter system.

More generally, the method described with reference to FIG. 3 may be applied with a parameterized algorithm suitable to be trained to achieve extrapolation or interpolation based on a training database populated with temporal trajectories. A so-called extrapolation neural network is an example of such a parameterized algorithm, but other parameterized algorithms may be applied instead of an extrapolation neural network.

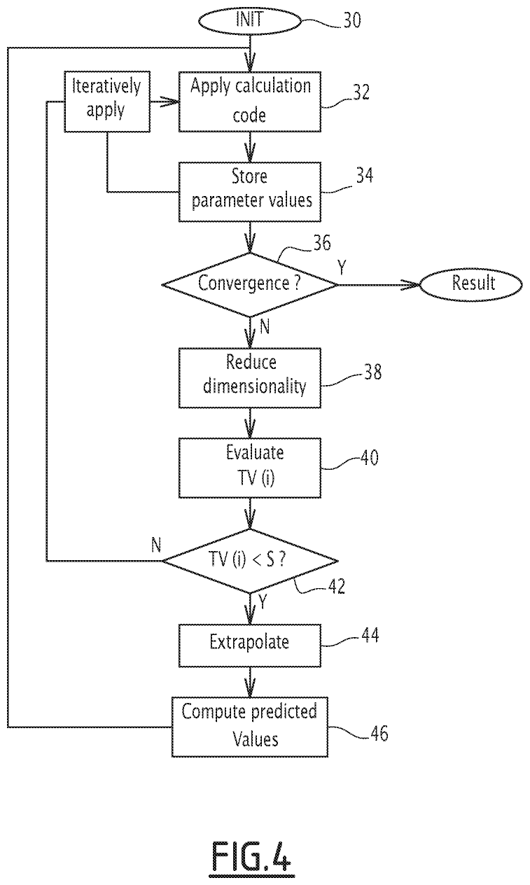

FIG. 4 is a flowchart of the main steps of a second embodiment of a method of accelerating the convergence of an iterative computation of physical parameters of a multi-parameter system.

A set of data 30, analogous to the set of data 10 described above, is provided as an initial input to a computation step 32 of an iterative computation code, analogous to step 12 already described with respect to the embodiment of FIG. 1.

Further, a storing step 34, analogous to step 14, and a convergence verification 36, analogous to test 16, are applied.

In case of positive validation of the convergence criterion is obtained at step 36, the set of output first parameter values obtained by the last application of the computation code is considered to be a valid result of the iterative computation code. Therefore, the computation process ends.

In case of negative validation of the converge criterion, step 36 is followed by step 38, analogous to step 18, of applying a data dimensionality reduction method, consisting in reducing the dimensionality of the first parameter space of the first dimensionality N to a second dimensionality M smaller than N. A second parameter space of second dimensionality is obtained.

In an embodiment, a principal component analysis (PCA) is applied.

Then, a step 40 of computing a variation rate for the first principal component is applied.

Step 40 comprises computing the variance of the first principal component at each iteration i, the first principal component is a vector of values, corresponding for example to the values of the parameters at different locations of the mesh of the modelled geometry.

Computing the variation rate of this vector aims at assessing the change of this vector according to the iterations. One could picture this as measuring the change in orientation and magnitude in the initial parameter space.

In an embodiment, the variation rate is computed according to the formula:

$$var ( X ) = \frac{1}{J} {\sum }_{i = 1}^{n} {\sum }_{j = 1}^{J} {( {x}_{ij} - {\overline{x}}_{i} )}^{2} \qquad ( EQ2 )$$

where J is a number of successive iteration batches of Q iterations, xᵢⱼ is the i^{th} component of the principal component of the j^{th} iteration batch, and xi is the average value of the i^{th} component.

Advantageously, the variation rate is a good indicator of a stabilization of the projection basis.

Alternatively, the variation rate computation as described above is applied on a chosen set of first components at each iteration i, the chosen set of first components being different from the first principal component.

Next, the variation rate is compared, at comparison step 42, to a predetermined threshold S, for example comprised between 0 and 40 percent, and preferably equal to 30%.

If the variation rate is higher than the predetermined threshold S, then steps 32 to 42 are repeated.

If the variation rate is lower than the predetermined threshold S, then step 42 is followed by an extrapolation step 44, analogous to step 20 described in reference to FIG. 1.

Alternatively, the embodiment of the extrapolation described with respect to FIG. 3 is applied, and an extrapolation neural network or a suitable parameterized algorithm is trained, and further applied to achieve the extrapolation of the second parameter values.

According to another variant, an already trained neural network is directly applied for extrapolation.

A set of predicted second parameter values is therefore obtained by computation.

Therefore, the variation rate is used for determining a subset of the second parameters to be used for extrapolation.

Extrapolation step 44 is followed by a step 46 of computing a set of predicted first parameter values, which is analogous to step 22 already described.

The set of predicted first parameters is then used as a set of input parameter values, and the steps 32 to 36 are repeated. If the convergence criterion is not reached at step 36, steps 38 to 46 are also repeated.

The inventors noted that advantageously, when the variation rate computed as shown for the first principal component is lower than a given threshold, the method is particularly efficient, i.e. the convergence is reached rapidly. Therefore, computation resources are saved, and the computation time is reduced.

According to an alternative, a neural network is applied, as explained with reference to FIG. 2, for data dimensionality reduction (step 38) and for computing a set of predicted first parameter values (step 46) from the extrapolated second parameter values.

In this alternative, the variation rate is computed for example, for one or several second parameter values. The variation rate computation of step 40 is applied analogously to the second parameter(s) selected.

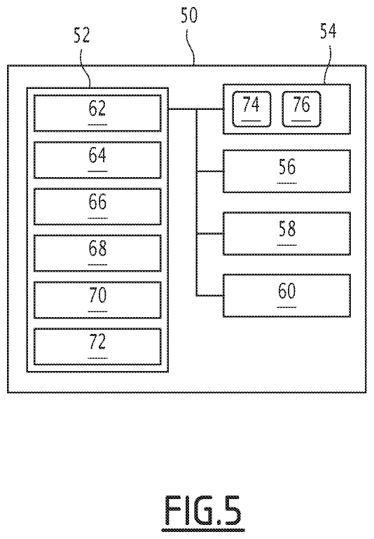

FIG. 5 is a block diagram of a device for accelerating the convergence of an iterative computation code of physical parameters of a multi-parameter system according to an embodiment.

The device 50 for accelerating the convergence of an iterative computation code is an electronic programmable device, such as a computer. Alternatively, the device 50 is a cluster interconnected of computers.

For the purpose of representation, a single device 50 is shown in FIG. 5.

The device 50 comprises a processing unit 52, composed of one or several processors, associated with an electronic memory unit 54. The electronic memory unit 54 is for example a ROM memory or a RAM memory.

Furthermore, the device 50 comprises, in an embodiment, a first man-machine interface 56, for example a screen, suitable for displaying information, and a second man-machine interface 58, suitable for the input of user commands. In an embodiment, these man-machine interfaces are formed as a single interface, such as a touch screen. The device 50 further comprises a communication unit 60 suitable for transmitting/receiving data via a wired or a wireless communication protocol.

All units of the device 50 a adapted to communicate via a communication bus.

The processing unit 52 is programmed to implement:
a module 62 for applying computation code of physical parameters, configured to compute first parameters and store the first parameters 74 in the memory unit 54, for post-processing;
a module 64 for checking for convergence according to a predetermined convergence criterion;
a module 66 for reducing dimensionality of the parameter space, adapted to computed second parameters and store the second parameters 76 in the memory unit 54;
a module 68 for applying a variation rate calculation on the values of a chosen second parameter;
a module 70 for applying extrapolation on at least a subset of the second parameters to obtain a set of predicted values of second parameters;
a module 72 for computing predicted values of first parameters from the set of predicted values of second parameters.

In an embodiment, all modules 62 to 72 are software modules comprising computer program instructions executable by the processor 52.

These modules form a computer program comprising instructions for implementing a method for accelerating the convergence of an iterative computation code of physical parameters of a multi-parameter system according to all described variants of the present disclosure.

This computer program is suitable for being recorded on a computer-readable medium, not shown. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card.

In a variant that is not shown, the modules 62 to 72 are each made in the form of a programmable logic component, such as an FPGA (Field Programmable Gate Array), a GPU (Graphic Processing Unit), or a GPGPU (General-Purpose Processing on Graphics Processing), or in the form of a dedicated integrated circuit, such as an ASIC (Application Specific Integrated Circuit).

What is claimed is:

1-13. (canceled)

14: A method for accelerating a convergence of an iterative computation code of physical parameters of a multi-parameter system, comprising the following steps, implemented by a processor of an electronic programmable device:
a) apply the iterative computation code, starting from an input data set, for a given number of iterations, to obtain first parameter values, of first dimensionality;
b) keep available, in a memory of said programmable device, the first parameter values for each iteration for post-processing;
c) check for iterations convergence according to a predetermined convergence criterion; and
d) if the predetermined convergence criterion is not satisfied then:
i. apply a data dimensionality reduction on at least a part of the first parameter values of first dimensionality to compute representative second parameters of second dimensionality smaller than the first dimensionality;
ii. apply an extrapolation on at least a subset of the second parameters of second dimensionality to predict a set of predicted second parameter values, and compute predicted first parameter values from the predicted second parameter values,
iii. use the predicted first parameter values as an input data set for a new iterative computation with the iterative computation code,
e) repeat steps a) to d) until the convergence according to the predetermined convergence criterion is reached.

15: The method according to claim 14, wherein the data dimensionality reduction comprises applying principal component analysis, and each representative second parameter is a principal component.

16: The method according to claim 15, wherein each principal component has an associated score, and the principal components are ordered according to decreasing associated score.

17: The method according to claim 14, wherein the data dimensionality reduction comprises applying an upstream first neural network, which is obtained by splitting an identity multi-layer neural network, comprising at least one hidden layer with a number of neurons smaller than the first dimensionality.

18: The method according to claim 17, wherein the computation of predicted first parameter values from the predicted second parameter values comprises applying a downstream second neural network, obtained by splitting said identity multi-layer neural network.

19: The method according to claim 14, wherein the extrapolation comprises applying auto-regressive integrated moving average.

20: The method according to claim 14, wherein the extrapolation comprises applying a parameterized algorithm trained on an available database.

21: The method according to claim 20, wherein the extrapolation comprises applying a computational extrapolation to predict second parameter values and store the predicted second parameter values as trajectories, and further apply training of the parameterized algorithm based on the stored trajectories.

22: The method according to claim 14, further comprising, after applying the data dimensionality reduction, computing a variation rate of values of at least one chosen second parameter associated to successive iterations of steps a) to d), and determining the subset of the second parameters used for extrapolation in function of said variation rate.

23: The method according to claim 22, wherein the data dimensionality reduction is principal component analysis, the principal components being ordered, and wherein said variation rate is computed for a first principal component.

24: The method according to claim 22, wherein the determining the subset of the second parameters used for extrapolation comprises comparing the variation rate to a predetermined threshold, and selecting second parameter values associated to iterations for which the variation rate is lower than said predetermined threshold.

25: The method according to claim 14, wherein the multi-parameter system is for fluid dynamics computation.

26: A non-transitory computer readable medium including software instructions which, when executed by a programmable electronic device, carry out the method as recited in claim 14.

27: A device for accelerating a convergence of an iterative computation code of physical parameters of a multi-parameter system, comprising at least one processor configured to implement:
a module configured for applying the iterative computation code, starting from an input data set, for a given number of iterations, and obtaining first parameter values, of first dimensionality;
a module configured to keep available, in a memory of the device, the first parameter values for each iteration for post-processing;
a module configured to check for iterations convergence according to a predetermined convergence criterion;
modules configured to, if the predetermined convergence criterion is not satisfied:
apply a data dimensionality reduction on at least a part of the first parameter values of first dimensionality to compute representative second parameters of second dimensionality smaller than the first dimensionality;
apply an extrapolation on at least a subset of the second parameters of second dimensionality to predict a set of predicted second parameter values, and compute predicted first parameter values from the predicted second parameter values,
use the predicted first parameter values as an input data set for a new iterative computation with the iterative computation code,
wherein the modules are applied repeatedly until the converge according to the predetermined convergence criterion is reached.

28: The device according to claim 27, wherein the multi-parameter system is for fluid dynamics computation.
